(19) United States
(12) Patent Application Publication
(10) Pub. No.: US 2015/0143663 A1
(43) Pub. Date: May 28, 2015

(54) DOOR CLOSING DEVICE

(71) Applicant: DORMA Deutschland GmbH, Ennepetal (DE)

(72) Inventor: Alexander HELLWIG, Ennepetal (DE)

(21) Appl. No.: 14/551,168

(22) Filed: Nov. 24, 2014

(30) Foreign Application Priority Data
Nov. 27, 2013 (DE) 102013113092.5

(51) Int. Cl. E05F 3/10; E05F 3/18

(52) U.S. Cl. CPC E05F 3/108; E05F 3/18
USPC 16/52; 16/65; 16/51; 29/428

(57) ABSTRACT

A door closing device having a housing, a lever interface for the attachment of a door closing mechanism (110), which interface is rotatably supported in the housing, a spring device, which charges the lever interface with a closing torque, and a dampening device for dampening the charging of the lever interface with the closing torque, where the housing is configured, at least in sections, as a cold-deformed structural member.

### CROSS REFERENCE TO RELATED APPLICATION

This application is related to and claims the benefit of German Patent Application Number 102013113092.5 filed on 27 Nov. 2013, the contents of which are herein incorporated by reference in their entirety.

### TECHNICAL FIELD

The present invention relates to a door closing device, as well as to a method for manufacturing a door closing device.

### BACKGROUND

It is known to equip doors with door closing devices in order to be able to provide for automatic closing of the door after an opening operation has been performed. Door closer devices are attached for this purpose either to the casing or to the door leaf and are articulated with a door closing mechanism at the opposite structural member. During the opening movement of the door leaf, a pre-tension can thereby be introduced into a spring device. Once the opening operation is completed, this pre-tension force can retroactively act upon said lever mechanism and perform the closing operation of the door. Usually, known spring devices are coupled to damping devices in order to be able to slowly perform the closing operation and not too fast.

In the known door closing devices, it is disadvantageous that relatively important expenditures are required for being able to provide the door closing device. These expenditures refer in particular to the material expense and the weight, which are necessary for such door closing devices. A decisive portion of said disadvantage is the configuration of a housing for the door closing device which often surrounds the spring device and/or the dampening device. Such a housing is usually manufactured from casting material, in order to be able to provide a force reception for the lever mechanism, respectively to be able to provide the spring device. This in turn results in high weight and simultaneously in high processing expenditure, because the casting part needs to be subsequently machined at appropriate bearing locations.

### BRIEF SUMMARY

Therefore, the present invention overcomes the above described disadvantages, at least partially. More particularly, the present invention provides manufacturing of the housing in an inexpensive and simple manner.

Features and details, described in conjunction with the inventive door closing device, are obviously also valid in conjunction with the inventive method and respectively vice versa, such that always mutual reference is made, respectively can be made with respect to the disclosure of individual aspects of the invention.

According to the invention, a door closing device is proposed having a housing, a lever interface for the attachment of a door closing mechanism, which lever interface is rotatably supported in the housing, as well as a spring device and a dampening device. The spring device charges the lever interface with a closing torque. The dampening device serves the purpose of providing a dampening when the lever interface is charged with the closing torque. The inventive door closing device is characterized in that the housing is configured, at least in sections, as a cold deformed structural member.

In contrast to the prior art solutions with housings made from casting material, according to the invention, a cold-deformed structural member is employed as a housing. A cold deformation may include for example a deep-drawing process or a bending process. In other words, the housing may be manufactured from plate-shaped raw material by means of one or more cold-deforming process steps. This translates into a potential utilization of inexpensive raw material in the shape of plates which are easy to store.

Moreover, by making use of cold-deforming process steps, a thin formation of the housing is made possible, namely having a thin walling thickness. Besides cost advantages in manufacturing, these features result in an advantageous weight, namely low weight of the housing at the door closing device. Last but not least, a cold-deforming manufacturing of the structural member for the housing allows for more flexibility in shaping than it was possible with the known casting process. Thereby, a lower volume extent may be achieved for the housing and thereby for the entire door closing device. This will allow for more compact methods of construction of the door closing devices than it has been the case with known solutions.

Obviously, in the inventive manner, the housing may surround both the spring device and the dampening device. Particularly, the housing serves for providing a fluid-tight boundary in order to prevent the dampening fluid from discharging from the door closing device. Individual sealing means, respectively sealing seams can be employed for this purpose. A soldered seam, a glued seam or else a welded seam may be employed as a sealing seam for example in butt seams between individual structural members of the housing.

Obviously, different steps can be likewise combined with each other for the cold deformation of the structural member. It is thus possible to perform a deep-drawing process to before or also after a bending process. According to the invention, it is essential that at least one portion of the housing is configured as a cold deformed structural member. The housing may thus be e. g. one single part, wherein a portion of or also the entire housing has been manufactured in a cold-deformation. Also two-part housings or housings in multiple parts are conceivable within the framework of the present invention. In this case, at least one portion of a housing part, preferably respectively an entire housing part, respectively all housing parts are configured as cold-deformed structural members.

The lever interface may be directly or indirectly rotatably supported in the housing, for example by means of a yet to be described bearing bushing. In this case, an operative connection is established between the lever interface and the spring device, which may be configured e. g. via a cam moving on an eccentric path. It is during rotation of the lever interface that a spring device can absorb force via an eccentric cam, which force, once the opening operation is completed, is able to act again upon the lever interface in the opposite direction. By eccentrically forming an appropriate cam, said operative connection is created for transferring the closing torque. In other words, the location of application of forces of the spring device includes a lever arm with regard to the axis of rotation of the lever interface. Thus, the provided force vector of the spring device transforms into an applied closing torque. Correspondingly, a torque is transferred onto the spring device and stored therein in the reverse manner, while the door is being opened.

A door closing mechanism can in this case be configured in a known manner, in particular as a lever mechanism. Said mechanism is for example attached with one end to the door casing and, with its other end, to the lever interface of the door closing device, wherein the door closing device can be configured to be movable together with the door leaf.

It is advantageous, if, in an inventive door closing device, the housing is configured, at least in sections, as a cold-deformed deep-drawn structural member. A deep-drawn structural member offers a particularly inexpensive and efficient manufacturing option for an inventive housing. It is preferred, if the entire housing is configured as a cold-deformed deep-drawn structural member. In such an embodiment, in particular the housing is integrally configured. Therefore, an essentially cylindrically-shaped extension can be achieved by deep-drawing the entire housing. Respectively remaining mounting openings allow for subsequent introduction of the spring device, the dampening device as well as the lever interface. This procedure does not only result in a simple and inexpensive manufacturing of the housing, but, moreover, also allows for an inexpensive and simple assembly of the door closing device. Moreover, in this manner essentially constant and especially thin walling thicknesses of the housing can be achieved for a constant fluid tightness.

It is likewise advantageous, if, in an inventive door closing device, the housing has at least two housing parts, which are configured as cold-deformed housing parts. A housing formation in multiple parts allows for a more flexible configuration of the subsequent assembly procedure for the door closing device. The cold-deformed housing parts are in particular cold-deformed deep-drawn structural members. This leads in turn to the fact that individual housing parts can be configured pot-like with a pot-bottom in a deep-drawing process. Said pot-bottom forms a respective fluid-tight terminal section, whereby a separate sealing of said terminal section is no longer necessary, because it is formed from the same material. This circumstance allows for reducing the sealing expense for an inventive door closing device during assembly. Mounting, respectively introducing the spring device, as well as the dampening device may be realized via the remaining deep-drawn opening of the respective housing part. The butt-joint between two or more structural members may be sealed to be fluid-tight for example by means of a soldered seam, a glued seam or a welded seam.

Another advantage can be achieved, if in an inventive door closing device, the housing includes at least one fluid-tight terminal section as a cold-deformed structural member. As already explained in the above paragraph, the respective housing part may be manufactured for example as a pot-like configuration. Consequently, the pot-bottom automatically forms the fluid-tight terminal section during the cold-deformation. Obviously, it is also conceivable that the latter be located on a side, namely in case of a fluid-tight terminal section in an integral housing.

It is furthermore advantageous, if, in an inventive door closer device, the housing has a cylindrically-shaped or an essentially cylindrically-shaped basic form. In this case, at least one radial cut-out is provided for the reception of a bearing bushing intended for the rotatable support of the lever interface. A cylindrically-shaped basic form allows for achieving a further reduction of the dimensions of the door closing device, respectively of the housing. Also in terms of pressure absorption, a reduced surface pressure, respectively a constant pressure distribution is achieved in the material of the housing. Via a radial cut-out, it is possible to introduce a bearing bushing, which may be configured with higher mechanical resistance forces for the support of the lever mechanism. Such a bearing bushing may be likewise configured as a single part or in multiple parts. A first bearing bushing component may be for example introduced from the top through a first radial cut-out, and a second bearing bushing component may be introduced from the bottom through a second radial cut-out into the housing and connected therein. Therefore, a mechanical supportability for the individual structural members, in particular the lever interface, is possible by means of manufacturing said bearing bushings for example as milled parts or as turned parts. In this case, the radial cut-out may be configured for example as a rectangular or essentially rectangular window.

Another advantage can be achieved, if, in an inventive door closing device, the housing includes at least one housing envelope, in which dampening channels of the dampening device are disposed. The housing envelope may be placed around the housing, respectively may be sprayed around the housing. Dampening channels may be provided in the housing envelope in the shape of grooves such that the remaining opening of the groove is covered by the housing. Therefore, a dampening device can be provided with all the necessary dampening channels, inexpensively, simply and moreover quickly and easily. Attaching and sealing the housing envelope to the rest of the housing is likewise realized for example by means of gluing, soldering or by means of pressing, respectively shrink-fitting the housing envelope. Obviously, it is likewise possible that valves are provided in the housing envelope which allow for introducing a corresponding valve functionality into the dampening channels of the dampening device.

A further advantage can be achieved, if, in an inventive door closer device, the housing has a constant or an essentially constant walling thickness. In particular with the bending processes from plate-shaped materials, respectively with the deep-drawing processes, this feature can be inexpensively and easily achieved. Thus, a particularly thin walling thickness may result in a reduced weight and a material saving manufacturing method for the entire housing.

It is likewise advantageous, if, in the inventive door closing device, at least one fluid-tight terminal section of the housing is configured as a housing cover, in particular as a cold-deformed housing cover. In this case, in such a configuration of the fluid-tight terminal section, it will be a separate structural member. During the mounting of the door closing device into a respective opening of the housing, at last the housing cover is therefore inserted and fluid-tight sealed. The sealing may be realized by means of separate sealing means or by means of an already explained gluing seam, soldered seam or welded seam. The corresponding covering by means of the housing cover is necessary, because an assembly, respectively the introduction of the spring device and/or the dampening device can be achieved through these openings, in particular with integral housings.

It is furthermore advantageous, if, in an inventive door closing device, the housing surrounds the spring device and the dampening device in a fluid-tight manner. This means that the housing represents the exterior termination for the door closing device, in particular with regard to the spring device and the dampening device. In the event the housing is configured in multiple parts, preferably one housing part corresponds to the dampening device and surrounds the latter. Correspondingly, another housing part preferably corresponds to the spring device and surrounds the latter. The fluid-tightness is made possible by means of correspondingly sealing the butt-joints between the individual housing parts. In particular with regard to the geometrical extension, the housing corresponds to the geometrical extension of the spring device, respectively of the dampening device such that a compact surrounding of those two devices is achieved by means of the housing.

Another subject matter of the present invention is a method for manufacturing a door closing device, in particular a door closing device according to the present invention, including the steps of:
cold-deforming, at least in sections, one structural member for manufacturing a housing,
disposing a spring device and a dampening device within the housing,
rotatably supporting a lever interface for the attachment of a door closing mechanism within the housing,
sealing the housing against fluid discharge.

By manufacturing an inventive door closing device, an inventive method includes the same advantages as the ones explained in detail with regard to an inventive door closing device. In particular, an inventive method can be employed for both an integral housing and for two-part housings or for housings in multiple parts.

### BRIEF DESCRIPTION OF THE DRAWINGS

Further advantages, features and details of the invention will result from the following description, in which exemplary embodiments of the invention are described in detail, reference being made to the drawings. In this context, the features mentioned in the claims and in the description, individually or randomly combined, may be essential to the invention, in which:

FIG. 1: diagrammatically shows a first embodiment of an inventive door closing device,

FIG. 2: diagrammatically shows another embodiment of an inventive door closing device during assembly,

FIG. 3: diagrammatically shows the completed door closing device according to FIG. 2 in a cross-section,

FIG. 4: diagrammatically shows the housing according to an embodiment of the FIGS. 2 and 3,

FIG. 5: diagrammatically shows an assembly situation of an inventive door closing device, and

FIG. 6: diagrammatically shows an embodiment of an inventive door closing device.

### DETAILED DESCRIPTION

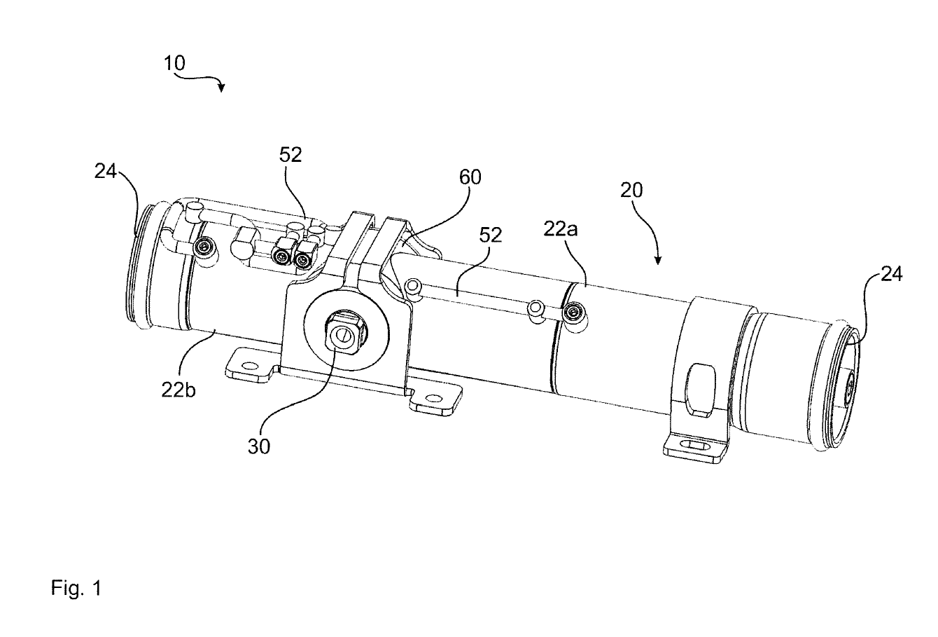

FIG. 1 shows an embodiment of an inventive door closing device 10. In this assembled condition, a housing 20 with two housing parts 22a and 22b is provided. A spring device 40 and a dampening device 50 are disposed within said two housing parts 22a and 22b, but cannot be recognized. The housing 20 has two fluid-tight terminal sections 24, which are configured in this case by means of a deep-drawing process as a pot-bottom of the two housing parts 22a and 22b.

Furthermore, FIG. 1 reveals that individual sections of the housing are connected via separate dampening channels 52 in the shape of fluid lines. Thereby, the dampening functionality can be provided for the door closing device 10.

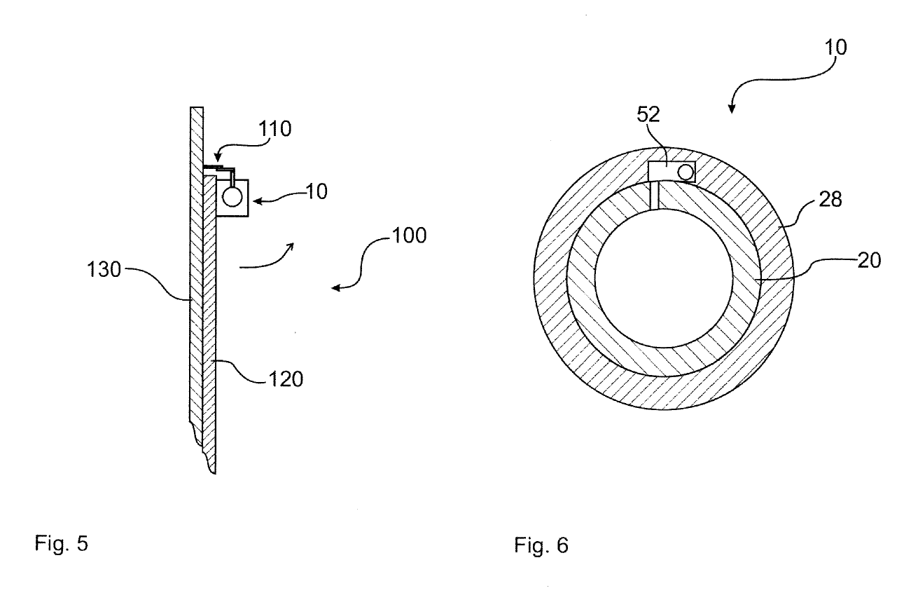

The door closing device 10 can be attached to a door 100, in particular to the door casing 130 and/or to the door leaf 120 via collar bands, as shown for example in FIG. 5.

Furthermore, FIG. 1 reveals that a lever interface 30 is rotatably supported in the housing 20. In this case, the support is realized via a bearing bushing 60, which is preferably configured as a turned part and/or as a milled part in order to provide for increased mechanical load-bearing capacity.

FIG. 5 shows, in a diagrammatical way, how one embodiment of the door closing device 10, for example according to FIG. 1, can be employed. The door closing device 10 is thus attached to the door leaf 120 of the door 100, in this case via corresponding collar bands. A contact to the door casing 130 is established via a door closing mechanism 110 in the shape of a lever mechanism. Now, if the door leaf 120 is opened along an opening movement, a corresponding correlating movement of the door closing mechanism 110 is performed, such that the force, respectively the torque can be stored in the spring device 40 of the door closing device 10. Upon ending the opening procedure, said stored energy is released again to the lever interface 30 and thus also to the door closing mechanism 110 such that the closing operation of the door 100 is automatically performed.

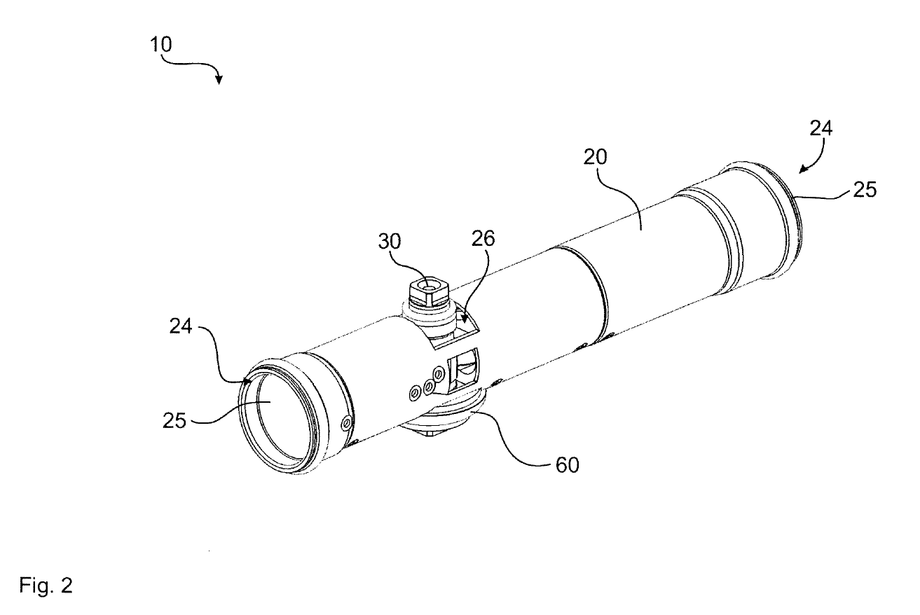

FIGS. 2 to 4 illustrate another embodiment of an inventive door closing device 10. Basically, the latter is based on the embodiment of FIG. 1. However, in this case, the housing 20 is configured as a single, essentially cylindrically-shaped deep-drawn part. In this case, openings remain at both ends such that a housing cover 25 is inserted, respectively in particular pressed in for forming the respective fluid-tight terminal section 24.

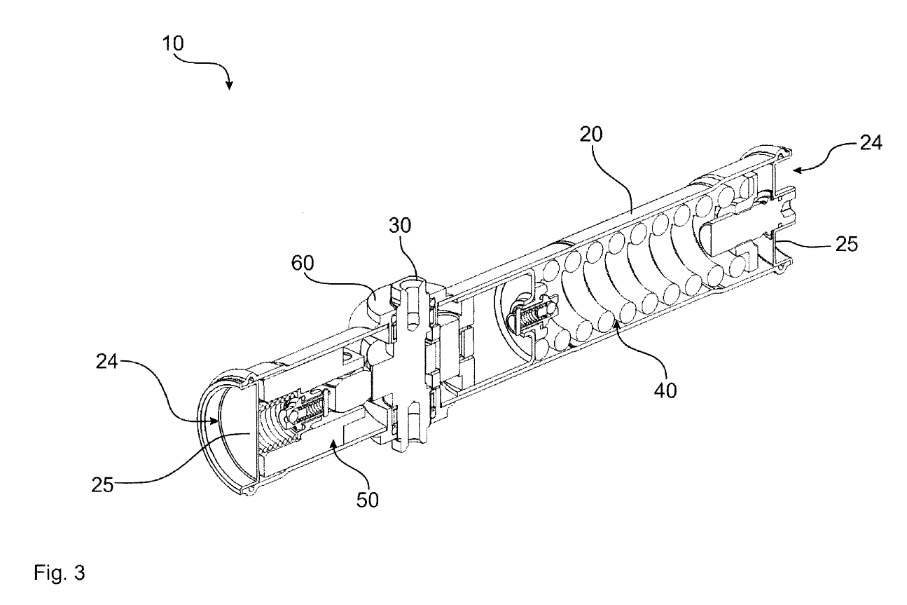

During assembly, as shown in FIG. 2, the bearing bushing 60, in this case in a two part manner, is inserted, from the bottom and from the top, into corresponding radial cut-outs 26, such that the necessary and inventive rotatable support of the lever interface 30 is guaranteed in the housing 20. Once assembly of the door closing device 10 is completed, all the structural members are installed, as shown in FIG. 3 in a diagrammatical cross-section. Herein, likewise a correlation, respectively an arrangement of the spring device 40, as well as of the dampening device 50 within the housing 20 can be seen. In this case, the spring device 40 is equipped herein with a spring element in the shape of a helical spring. However, obviously other spring shapes are possible for the spring device 40. A cam-shaped operative connection is provided between the lever interface 30 and the spring device 40, such that, depending on the direction of movement of the door leaf 120, an appropriate closing piston can pre-tension or expand the spring device 40.

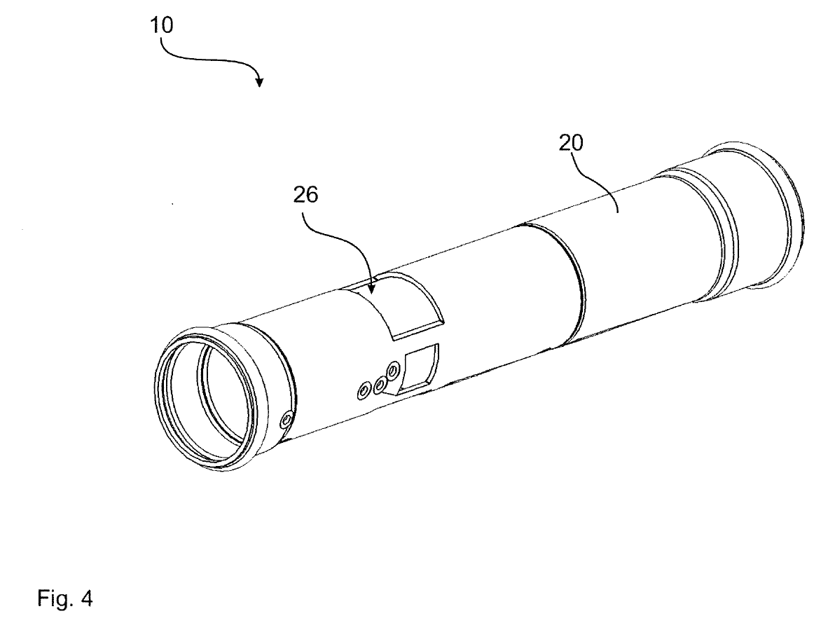

FIG. 4 shows an inventively manufactured housing 20 in an integral embodiment as employed in the embodiment of the FIGS. 2 and 3.

In FIG. 6 another embodiment of an inventive door closing device 10 is illustrated. Herein, the housing 20 includes a housing envelope 28. The latter bears against and surrounds the housing 20 and is provided with groove-shaped dampening channels 52. External fluid lines can thus be foregone and the dampening device 50 can be equipped with the appropriate functionality in a considerably less expensive, simpler and moreover more compact way.

The above explanation of the embodiment describes the present invention exclusively based on examples. Obviously, individual features of the embodiments, as long as technically reasonable, can be combined independently of each other without leaving the scope of the present invention.

1. A door closing device (10) having a housing (20), a lever interface (30) for the attachment of a door closing mechanism (110), which interface is rotatably supported in the housing (20), a spring device (40), which charges the lever interface (30) with a closing torque, and a dampening device (50) for dampening the charging of the lever interface (30) with the closing torque, characterized in that the housing (20) is configured, at least in sections, as a cold-deformed structural member.

2. The door closing device (10) according to claim 1, characterized in that the housing (20) is configured, at least in sections, as a cold-deformed deep-drawn structural member.

3. The door closing device (10) according any of the preceding claims, characterized in that the housing (20) includes at least two housing parts (22a, 22b), which are configured in particular as cold-deformed housing parts (22a, 22b).

4. The door closing device (10) according any of the preceding claims, characterized in that the housing (20) includes at least one fluid-tight terminal section (24) as a cold-deformed structural member.

5. The door closing device (10) according any of the preceding claims, characterized in that the housing (20) includes a cylindrically-shaped or an essentially cylindrically-shaped basic form, wherein at least one radial cut-out (26) is provided for the reception of a bearing bushing (60) intended for the rotatable support of the lever interface (30).

6. The door closing device (10) according any of the preceding claims, characterized in that the housing (20) includes at least one housing envelope (28), in which dampening channels (52) of the dampening device (50) are disposed.

7. The door closing device (10) according any of the preceding claims, characterized in that the housing (20) includes a constant or an essentially constant walling thickness.

8. The door closing device (10) according any of the preceding claims, characterized in that at least one fluid-tight terminal section (24) of the housing (20) is configured as a housing cover (25), in particular as a cold-deformed housing cover (25).

9. The door closing device (10) according any of the preceding claims, characterized in that the housing (20) surrounds the spring device (40) and the dampening device (50) in a fluid-tight manner.

10. A method for manufacturing a door closing device (10), in particular having the features of any of the claims 1 to 9, including the steps of:
cold-deforming, at least in sections, of one structural member for manufacturing a housing (20),
disposing a spring device (40) and a dampening device (50) within the housing (20),
rotatably supporting a lever interface (30) for the attachment of a door closing mechanism (110) within the housing (20),
sealing the housing (20) against fluid discharge.
